(19) United States
(12) Patent Application Publication
(10) Pub. No.: US 2015/0264368 A1
(43) Pub. Date: Sep. 17, 2015

(54) METHOD TO BYPASS RE-SAMPLING PROCESS IN SHVC WITH BIT-DEPTH AND 1X SCALABILITY

(71) Applicant: SONY CORPORATION, Tokyo (JP)

(72) Inventor: Cheung Auyeung, Sunnyvale, CA (US)

(21) Appl. No.: 14/635,911

(22) Filed: Mar. 2, 2015

Related U.S. Application Data
(60) Provisional application No. 61/953,047, filed on Mar. 14, 2014.
(60) Provisional application No. 61/954,281, filed on Mar. 17, 2014.

(51) Int. Cl. H04N 19/30; H04N 19/184; H04N 19/59; H04N 19/187

(52) U.S. Cl. CPC H04N 19/30; H04N 19/187; H04N 19/184; H04N 19/59

(57) ABSTRACT

When bit-depth scalability is enabled with 1× scalability, Scalable HEVC Model 5.0 (SHM-5.0) does not match the description of SHVC working draft 5. Two alternate fixes to the SHM-5.0 software for bit-depth and 1× scalability are described herein.

### CROSS-REFERENCE TO RELATED APPLICATION(S)

This application claims priority under 35 U.S.C. §119(e) of the U.S. Provisional Patent Application Ser. No. 61/953,047, filed Mar. 14, 2014 and titled, “A method to bypass re-sampling process in SHVC with bit-depth and 1× scalability” and U.S. Provisional Patent Application Ser. No. 61/954,281, filed Mar. 17, 2014 and titled, “A method to bypass re-sampling process in SHVC with bit-depth and 1× scalability,” which are both hereby incorporated by reference in their entireties for all purposes.

### FIELD OF THE INVENTION

The present invention relates to the field of data processing. More specifically, the present invention relates to video processing.

### BACKGROUND OF THE INVENTION

SHVC is a scalable extension to High Efficiency Video Coding (HEVC) which provides high quality video at a reduced bandwidth. SHVC includes a scalable format that is able to be adapted to meet network conditions. Both features are highly desirable characteristics of adaptive video streaming applications in bandwidth-constrained, wireless networks.

### SUMMARY OF THE INVENTION

When bit-depth scalability is enabled with 1× scalability, Scalable HEVC Model 5.0 (SHM-5.0) does not match the description of SHVC working draft 5. Two alternate fixes to the SHM-5.0 software for bit-depth and 1× scalability are described herein.

In one aspect, a method programmed in a non-transitory memory of a device comprises acquiring video content, including storing the video content in the non-transitory memory of the device and processing the video content, including joint re-sampling and bit-shift including determining if the base layer and the enhancement layer are a same size, and if the base layer and the enhancement layer are the same size, then bit-shift within a window is performed, and if the base layer and the enhancement layer are not the same size, then re-sampling and bit-shift is performed within the window. Processing further includes generating a bitstream. The method further comprises displaying the video content on a display. Processing further includes performing a base layer encoding loop and an enhancement layer encoding loop. Processing further includes joint re-sampling and bit-shift if any of the following is not true: the base layer and the enhancement layer of the video content are the same size, have a same bit-depth, and have a zero offset.

In another aspect, a system comprises an image sensor configured for acquiring video content and a processing device configured for processing the video content, including joint re-sampling and bit-shift including determining if the base layer and the enhancement layer are a same size, and if the base layer and the enhancement layer are the same size, then bit-shift within a window is performed, and if the base layer and the enhancement layer are not the same size, then re-sampling and bit-shift is performed within the window and a display device configured for displaying the video content. Processing further includes generating a bitstream. Processing further includes performing a base layer encoding loop and an enhancement layer encoding loop. Processing further includes joint re-sampling and bit-shift if any of the following is not true: the base layer and the enhancement layer of the video content are the same size, have a same bit-depth, and have a zero offset.

In another aspect, an apparatus comprises a non-transitory memory for storing an application, the application for: acquiring video content, including storing the video content in the non-transitory memory of the device and processing the video content, including joint re-sampling and bit-shift including determining if the base layer and the enhancement layer are the same size, and if the base layer and the enhancement layer are the same size, then bit-shift within a window is performed, and if the base layer and the enhancement layer are not the same size, then re-sampling and bit-shift is performed within the window and a processing component coupled to the memory, the processing component configured for processing the application. Processing further includes generating a bitstream. The apparatus further comprises a display configured for displaying the video content. Processing further includes performing a base layer encoding loop and an enhancement layer encoding loop. Processing further includes joint re-sampling and bit-shift if any of the following is not true: the base layer and the enhancement layer of the video content are the same size, have a same bit-depth, and have a zero offset.

In another aspect, a method programmed in a non-transitory memory of a device comprises acquiring video content, including storing the video content in the non-transitory memory of the device and processing the video content, including implementing joint re-sampling and bit-shift without previously determining if a base layer and an enhancement layer of the video content are a same size, have a same bit-depth, and have a zero offset. Processing further includes generating a bitstream. The method further comprises displaying the video content on a display. Processing further includes performing a base layer encoding loop and an enhancement layer encoding loop. The joint re-sampling and bit-shift include determining if the base layer and the enhancement layer are the same size, and if the base layer and the enhancement layer are the same size, then bit-shift within a window is performed, and if the base layer and the enhancement layer are not the same size, then re-sampling and bit-shift is performed within the window.

In another aspect, a system comprises an image sensor configured for acquiring video content and a processing device configured for processing the video content, including implementing joint re-sampling and bit-shift without previously determining if a base layer and an enhancement layer of the video content are a same size, have a same bit-depth, and have a zero offset and a display device configured for displaying the video content. Processing further includes generating a bitstream. Processing further includes performing a base layer encoding loop and an enhancement layer encoding loop. The joint re-sampling and bit-shift include determining if the base layer and the enhancement layer are the same size, and if the base layer and the enhancement layer are the same size, then bit-shift within a window is performed, and if the base layer and the enhancement layer are not the same size, then re-sampling and bit-shift is performed within the window.

In another aspect, an apparatus comprises a non-transitory memory for storing an application, the application for: acquiring video content, including storing the video content in the non-transitory memory of the device and processing the video content, including implementing joint re-sampling and bit-shift without previously determining if a base layer and an enhancement layer of the video content are a same size, have a same bit-depth, and have a zero offset and a processing component coupled to the memory, the processing component configured for processing the application. Processing further includes generating a bitstream. The apparatus further comprises a display configured for displaying the video content. Processing further includes performing a base layer encoding loop and an enhancement layer encoding loop. The joint re-sampling and bit-shift include determining if the base layer and the enhancement layer are the same size, and if the base layer and the enhancement layer are the same size, then bit-shift within a window is performed, and if the base layer and the enhancement layer are not the same size, then re-sampling and bit-shift is performed within the window.

### BRIEF DESCRIPTION OF THE DRAWINGS

FIG. 1 illustrates a flowchart of a mismatch in SHVC and SHM-5.0 according to some embodiments.

FIG. 2 illustrates a flowchart of the SHM-5.0 implementation according to some embodiments.

FIG. 3 illustrates a flowchart of a modified implementation according to some embodiments.

FIG. 4 illustrates a flowchart of a modified implementation according to some embodiments.

FIG. 5 illustrates a flowchart of video processing according to some embodiments.

FIG. 6 illustrates a block diagram of an exemplary computing device configured to implement the video processing method according to some embodiments.

### DETAILED DESCRIPTION OF THE PREFERRED EMBODIMENT

Scalable High Efficiency Video Coding (SHVC) derives the inter layer reference picture ilRefPic of the enhancement layer (EL) from the decoded reference layer picture rlPic of the base layer (BL). In Section H.8.1.4 of SHVC working draft 5, JCTVC-P1008 v4, when EL and the BL have the same picture sizes, the same bit depths, and have zero scaled reference layer offset between the BL and the EL, the ilRefPic is set equal to rlPic. Otherwise, the ilRefPic is derived from the rlPic with a resampling process which, in general, is a computationally intensive process including 2D filtering and sampling.

In particular, when the EL and the BL have the same picture size but different bit depths, the SHVC Draft 5 specifies that the resampling process is applied to the riPic to derive the ilRefPic. To reduce computation, when the EL and the BL have the same picture size, the rlPic is derived from the ilRefPic directly and without the resampling process.

When bit-depth scalability is enabled with 1× scalability, Scalable HEVC Model 5.0 (SHM-5.0) software does not match the description of SHVC working draft 5. Two alternate fixes to the SHM-5.0 software for bit-depth and 1× scalability are described herein.

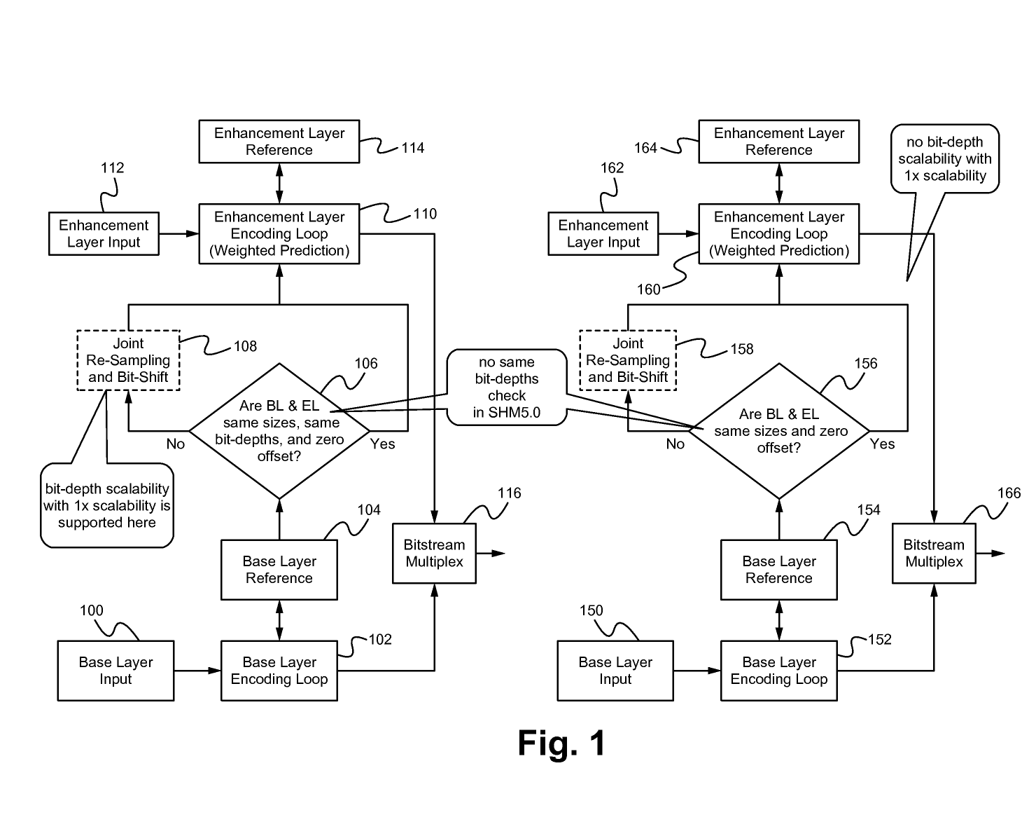

As shown in FIG. 1, SHVC draft 5, section H.8.1.4 specified that when the base layer and enhancement layer have the same picture sizes, same internal bit-depths, and zero scaled reference layer offsets, the inter-layer reference picture ilRefPic is set equal to the decoded reference layer picture rlPic.

In FIG. 1, in the SHVC Draft 5, the base layer 100 is input for base layer encoding loop 102. The output of the base layer encoding loop 102 goes to the base layer reference 104 and the bitstream multiplex 116. The output of the base layer reference 104 is used to determine if the BL and EL are the same size, have the same bit-depths, and have a zero offset, in the step 106. If the conditions are not true in the step 106, then joint re-sampling and bit-shift 108 is implemented using the output of the base layer reference 104, and the output of the joint re-sampling and bit-shift 108 goes to the enhancement layer encoding loop 110 which also uses enhancement layer input 112 and enhancement layer reference 114. If the conditions are true in the step 106, then enhancement layer encoding 110 is implemented using the output of the base layer reference 104 and the enhancement layer input 112 and enhancement layer reference 114. The output of the enhancement layer encoding loop 110 also goes to the bitstream multiplex 116.

In FIG. 1, in the SHM-5.0, the base layer 150 is input for base layer encoding loop 152. The output of the base layer encoding loop 152 goes to the base layer reference 154 and the bitstream multiplex 166. The output of the base layer reference 154 is used to determine if the BL and EL are the same size and have a zero offset, in the step 156. If the conditions in the step 156 are not true, then joint re-sampling and bit-shift 158 is implemented using the output of the base layer reference 104, and the output of the joint re-sampling and bit-shift 158 goes to the enhancement layer encoding loop 160 which also uses enhancement layer input 162 and enhancement layer reference 164. If the conditions in the step 156 are true, then enhancement layer encoding 160 is implemented using the output of the base layer reference 104 and the enhancement layer input 162 and enhancement layer reference 164. The output of the enhancement layer encoding loop 160 also goes to the bitstream multiplex 166.

However, the SHM-5.0 does not check if the BL and EL have the same bit-depths. In SHM-5.0, when the base layer and enhancement layer have the same picture sizes and zero scaled reference layer offset, the inter-layer reference picture ilRefPic is set equal to the decoded reference layer picture rlPic without checking the bit-depth difference of BL and EL. Consequently, SHM-5.0 does not support bit-depth scalability with 1× scalability in the inter-layer prediction process.

### Fix for SHM Software

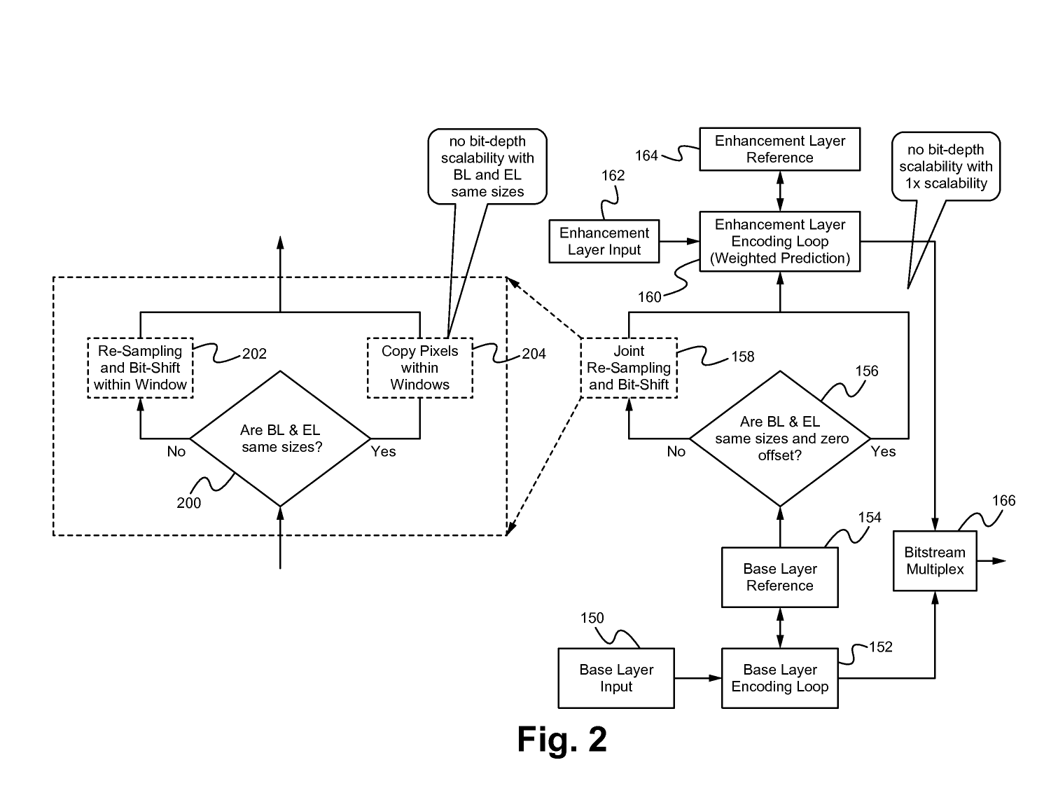

Two alternate implementations to fix the bit-depth and 1× scalability bug in SHM-5.0 depicted in FIG. 2 are described. To fix the bug, the joint resampling and bit-shift process and the corresponding bypass decision in SHM-5.0 are modified.

In FIG. 2, in the SHM-5.0 the base layer 150 is input for base layer encoding loop 152. The output of the base layer encoding loop 152 goes to the base layer reference 154 and the bitstream multiplex 166. The output of the base layer reference 154 is used to determine if the BL and EL are the same size and have a zero offset, in the step 156. If the conditions in the step 156 are not true, then joint re-sampling and bit-shift 158 is implemented using the output of the base layer reference 154, and the output of the joint re-sampling and bit-shift 158 goes to the enhancement layer encoding loop 160 which also uses enhancement layer input 162 and enhancement layer reference 164. If the conditions in the step 156 are true, then enhancement layer encoding 160 is implemented using the output of the base layer reference 154 and the enhancement layer input 162 and enhancement layer reference 164. The output of the enhancement layer encoding loop 160 also goes to the bitstream multiplex 166. In the joint re-sampling and bit-shift 158, it is determined if BL and EL are the same size, in the step 200. If BL and EL are not the same size, then re-sampling and bit-shift within a window are implemented, in the step 202. If BL and EL are the same size, then pixels are copied within the windows, in the step 204.

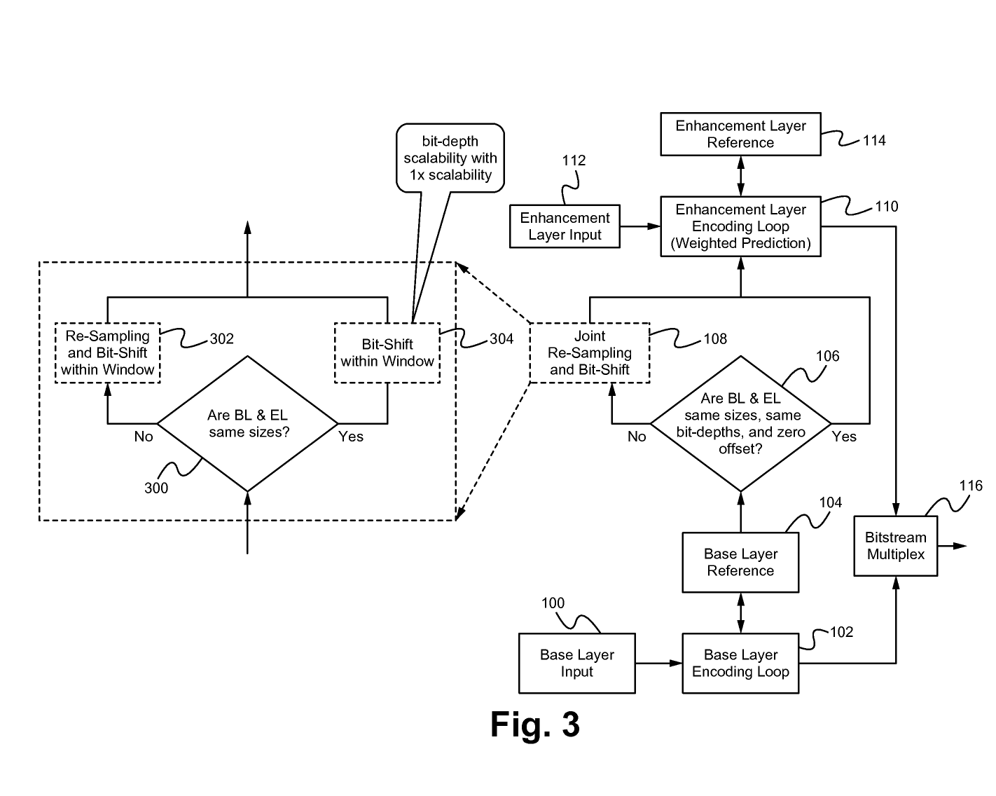

As shown in FIG. 3, the first bug fix implementation adds bit-shift in 304 for the same picture size with BL and EL to the joint resampling and bit-shift process. The bug fix also adds the bit-depth check back to the bypass decision in 106 to align with the SHVC draft 5.

In FIG. 3, the base layer 100 is input for base layer encoding loop 102. The output of the base layer encoding loop 102 goes to the base layer reference 104 and the bitstream multiplex 116. The output of the base layer reference 104 is used to determine if the BL and EL are the same size, have the same bit-depths, and have a zero offset, in the step 106. If the conditions in the step 106 are not true, then joint re-sampling and bit-shift 108 is implemented using the output of the base layer reference 104, and the output of the joint re-sampling and bit-shift 108 goes to the enhancement layer encoding loop 110 which also uses enhancement layer input 112 and enhancement layer reference 114. If the conditions in the step 106 are true, then enhancement layer encoding 110 is implemented using the output of the base layer reference 104 and the enhancement layer input 112 and enhancement layer reference 114. The output of the enhancement layer encoding loop 110 also goes to the bitstream multiplex 116. In the joint re-sampling and bit-shift 108, it is determined if BL and EL are the same size, in the step 300. If BL and EL are not the same size, then re-sampling and bit-shift within a window are implemented, in the step 302. If BL and EL are the same size, there is a bit-shift within the window, in the step 304.

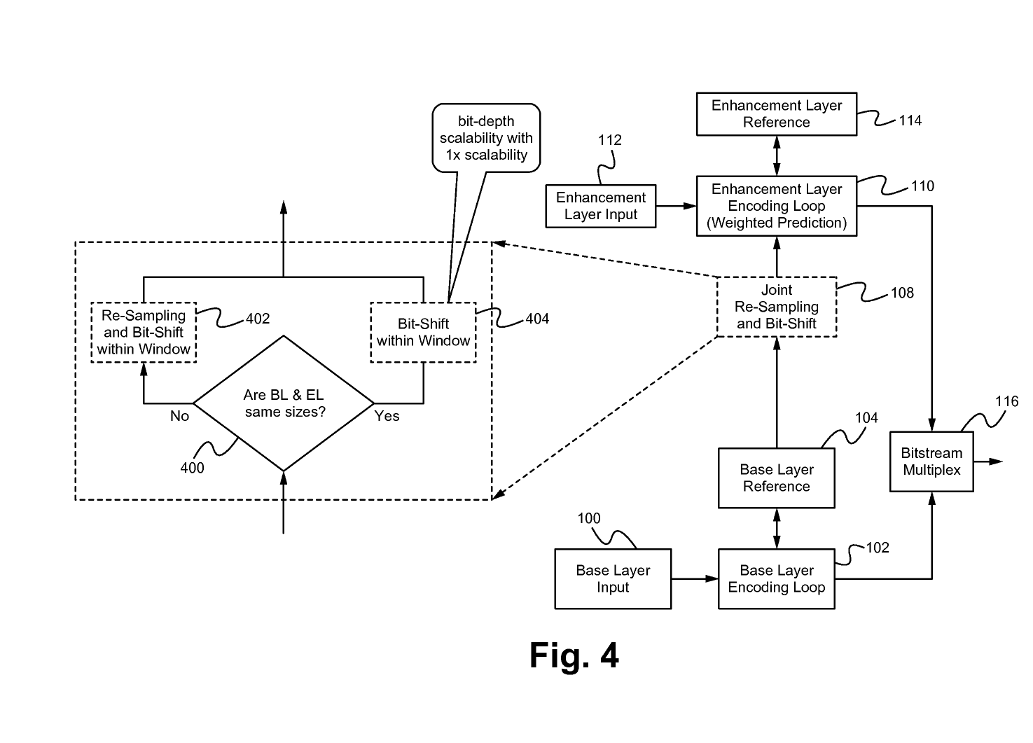

As shown in FIG. 4, the second bug fix implementation adds bit-shift in 404 for the same picture size with BL and EL to the joint resampling and bit-shift process. In contrast to the first implementation, the second bug fix removes the bypass decision, since the bypass decision in the working draft is not necessary to specify the behavior of the decoder.

In FIG. 4, the base layer 100 is input for base layer encoding loop 102. The output of the base layer encoding loop 102 goes to the base layer reference 104 and the bitstream multiplex 116. The output of the base layer reference 104 goes to joint re-sampling and bit-shift 108. The output of the joint re-sampling and bit-shift 108 goes to the enhancement layer encoding loop 110 which also uses enhancement layer input 112 and enhancement layer reference 114. The output of the enhancement layer encoding loop 110 also goes to the bitstream multiplex 116. In the joint re-sampling and bit-shift 108, it is determined if BL and EL are the same size, in the step 400. If BL and EL are not the same size, then re-sampling and bit-shift within a window are implemented, in the step 402. If BL and EL are the same size, there is a bit-shift within the window, in the step 404.

The bug fix was implemented in the SCE1 anchor and tested with the Quantization Parameters (QPs) in Table 1 from SHM SNR scalability common test conditions using the SCE1 test sequences in Table 2. The BDR results for the two fixes are the same, and they are in Table 3.

TABLE 1
SHM common test conditions QPs for 1x scalability.

| Test cases | Base layer | Enhancement layer |
|---|---|---|
| 1x: RA and | 1080p 8-bit BT.709 | 1080p 10-bit BT.709 |
| AI | QP_BL = {26, 30, 34, 38} | QP_EL1 = {20, 24, 28, 32} |
| | | QP_EL2 = {22, 26, 30, 34} |

TABLE 2
SCE1 BT709 test sequences.

| Test Sequences | Size | fps | Duration | Bit-depth |
|---|---|---|---|---|
| BT709_Birthday_1920x1080_60_zerophase_0.9pi.yuv | 1920 × 1080 | 60 | 300 | 8 |
| BT709_BirthdayFlashPart1_1920x1080_60_zerophase_0.9pi.yuv | 1920 × 1080 | 60 | 300 | 8 |
| BT709_BirthdayFlashPart2_1920x1080_60_zerophase_0.9pi.yuv | 1920 × 1080 | 60 | 300 | 8 |
| BT709_Parakeets_1920x1080_50_zerophase_0.9pi.yuv | 1920 × 1080 | 50 | 250 | 8 |
| BT709_TableCar_1920x1080_60_zerophase_0.9pi.yuv | 1920 × 1080 | 60 | 300 | 8 |
| BT709_Birthday_1920x1080_60_10bit_zerophase_0.9pi.yuv | 1920 × 1080 | 60 | 300 | 10 |
| BT709_BirthdayFlashPart1_1920x1080_60_10bit_zerophase_0.9pi.yuv | 1920 × 1080 | 60 | 300 | 10 |
| BT709_BirthdayFlashPart2_1920x1080_60_10bit_zerophase_0.9pi.yuv | 1920 × 1080 | 60 | 300 | 10 |
| BT709_Parakeets_1920x1080_50_10bit_zerophase_0.9pi.yuv | 1920 × 1080 | 50 | 250 | 10 |
| BT709_TableCar_1920x1080_60_10bit_zerophase_0.9pi.yuv | 1920 × 1080 | 60 | 300 | 10 |

TABLE 3
Anchor is SCE1 anchor, and test is SCE1 anchor with bug fix.

| | AI HEVC 1x 8-bit base | | |
|---|---|---|---|
| | Y | U | V |
| Class A+ | −28.0% | −27.4% | −27.9% |
| Overall (Test vs. Ref) | −28.0% | −27.4% | −27.9% |
| Overall (Test vs. single layer) | 13.5% | 13.9% | 13.2% |
| Overall (Ref vs. single layer) | 57.8% | 57.3% | 57.4% |
| EL only (Test vs. Ref) | −50.6% | −50.5% | −50.9% |
| Overall (Test EL + BL vs. single EL + BL) | −27.9% | −28.7% | −28.6% |
| BL Match | Matched | | |
| | AI HEVC 1x 8-bit base | | |
| | Y | U | V |
| Class A+ | −17.9% | −15.1% | −16.2% |
| Overall (Test vs. Ref) | −17.9% | −15.1% | −16.2% |
| Overall (Test vs. single layer) | 24.2% | 27.3% | 25.6% |
| Overall (Ref vs. single layer) | 51.5% | 50.1% | 50% |
| EL only (Test vs. Ref) | −30.6% | −28.0% | −28.9% |
| Overall (Test EL + BL vs. single EL + BL) | −18.9% | −17.3% | −17.7% |

| | |
|---|---|
| BL Match | Matched |

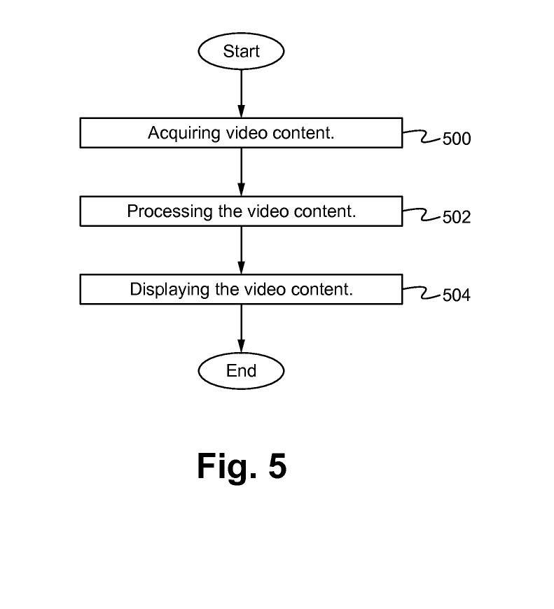

FIG. 5 illustrates a flowchart of a video processing method according to some embodiments. In the step 500, video content is acquired. The video content is able to be acquired in any manner such as capturing a video using a digital video camera or by transmitting the video content. In the step 502, the video content is processed (e.g., encoded and/or decoded) using the method described herein. Specifically, the method determines if the bit-depths of the BL and EL are the same, in addition to the other steps described. Alternatively, the method skips the step of comparing the BL and EL. In the step 504, the video content is displayed. In some embodiments, fewer or additional steps are implemented. In some embodiments, the order of the steps is modified.

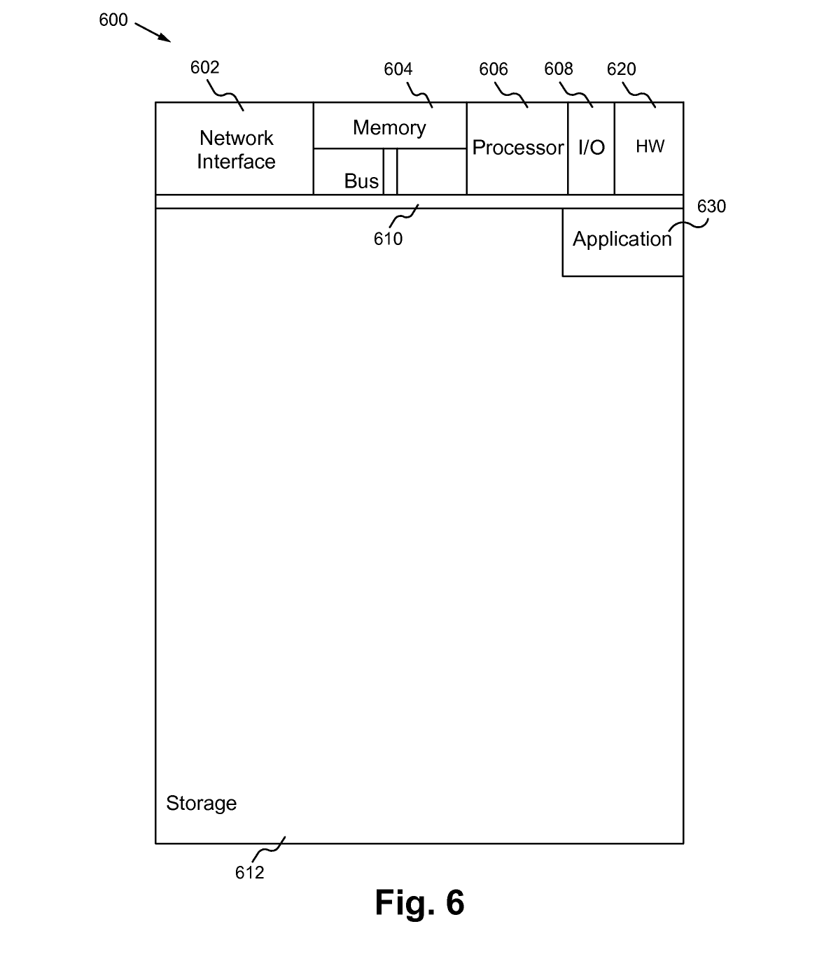

FIG. 6 illustrates a block diagram of an exemplary computing device configured to implement the video processing method according to some embodiments. The computing device 600 is able to be used to acquire, store, compute, process, communicate and/or display information such as images and videos. In general, a hardware structure suitable for implementing the computing device 600 includes a network interface 602, a memory 604, a processor 606, I/O device(s) 608, a bus 610 and a storage device 612. The choice of processor is not critical as long as a suitable processor with sufficient speed is chosen. The memory 604 is able to be any conventional computer memory known in the art. The storage device 612 is able to include a hard drive, CDROM, CDRW, DVD, DVDRW, High Definition disc/drive, ultra-HD drive, flash memory card or any other storage device. The computing device 600 is able to include one or more network interfaces 602. An example of a network interface includes a network card connected to an Ethernet or other type of LAN. The I/O device(s) 608 are able to include one or more of the following: keyboard, mouse, monitor, screen, printer, modem, touchscreen, button interface and other devices. Video processing application(s) 630 used to perform the video processing method are likely to be stored in the storage device 612 and memory 604 and processed as applications are typically processed. More or fewer components shown in FIG. 6 are able to be included in the computing device 600. In some embodiments, video processing hardware 620 is included. Although the computing device 600 in FIG. 6 includes applications 630 and hardware 620 for the video processing method, the video processing method is able to be implemented on a computing device in hardware, firmware, software or any combination thereof. For example, in some embodiments, the video processing applications 630 are programmed in a memory and executed using a processor. In another example, in some embodiments, the video processing hardware 620 is programmed hardware logic including gates specifically designed to implement the video processing method.

In some embodiments, the video processing application(s) 630 include several applications and/or modules. In some embodiments, modules include one or more sub-modules as well. In some embodiments, fewer or additional modules are able to be included.

Examples of suitable computing devices include a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player (e.g., DVD writer/player, high definition disc writer/player, ultra high definition disc writer/player), a television, an augmented reality device, a virtual reality device, a home entertainment system, smart jewelry (e.g., smart watch) or any other suitable computing device.

To utilize the video processing method, a device such as a digital video camera is able to be used to acquire a video. The video processing method is automatically implemented during or after acquiring a video such as during playback of the video. The video processing method is able to be implemented automatically without user involvement.

In operation, video processing method reduces the computation of SHVC when the input or the EL is a high dynamic range (HDR) video and the input of the BL is a standard dynamic range (SDR) or low dynamic range (LDR) video.

Some Embodiments of a Method to Bypass Re-Sampling Process in SHVC with Bit-Depth and 1× Scalability
1. A method programmed in a non-transitory memory of a device comprising:
   a. acquiring video content, including storing the video content in the non-transitory memory of the device; and
   b. processing the video content, including joint re-sampling and bit-shift including determining if the base layer and the enhancement layer are a same size, and if the base layer and the enhancement layer are the same size, then bit-shift within a window is performed, and if the base layer and the enhancement layer are not the same size, then re-sampling and bit-shift is performed within the window.
2. The method of clause 1 wherein processing further includes generating a bitstream.
3. The method of clause 1 further comprising displaying the video content on a display.
4. The method of clause 1 wherein processing further includes performing a base layer encoding loop and an enhancement layer encoding loop.
5. The method of clause 1 wherein processing further includes joint re-sampling and bit-shift if any of the following is not true: the base layer and the enhancement layer of the video content are the same size, have a same bit-depth, and have a zero offset.
6. A system comprising:
   a. an image sensor configured for acquiring video content; and
   b. a processing device configured for processing the video content, including joint re-sampling and bit-shift including determining if the base layer and the enhancement layer are a same size, and if the base layer and the enhancement layer are the same size, then bit-shift within a window is performed, and if the base layer and the enhancement layer are not the same size, then re-sampling and bit-shift is performed within the window; and
   c. a display device configured for displaying the video content.
7. The system of clause 6 wherein processing further includes generating a bitstream.
8. The system of clause 6 wherein processing further includes performing a base layer encoding loop and an enhancement layer encoding loop.
9. The system of clause 6 wherein processing further includes joint re-sampling and bit-shift if any of the following is not true: the base layer and the enhancement layer of the video content are the same size, have a same bit-depth, and have a zero offset.
10. An apparatus comprising:
   a. a non-transitory memory for storing an application, the application for:
      i. acquiring video content, including storing the video content in the non-transitory memory of the device; and
      ii. processing the video content, including joint re-sampling and bit-shift including determining if the base layer and the enhancement layer are a same size, and if the base layer and the enhancement layer are the same size, then bit-shift within a window is performed, and if the base layer and the enhancement layer are not the same size, then re-sampling and bit-shift is performed within the window; and
   b. a processing component coupled to the memory, the processing component configured for processing the application.
11. The apparatus of clause 10 wherein processing further includes generating a bitstream.
12. The apparatus of clause 10 further comprising a display configured for displaying the video content.
13. The apparatus of clause 10 wherein processing further includes performing a base layer encoding loop and an enhancement layer encoding loop.
14. The apparatus of clause 10 wherein processing further includes joint re-sampling and bit-shift if any of the following is not true: the base layer and the enhancement layer of the video content are the same size, have a same bit-depth, and have a zero offset.
15. A method programmed in a non-transitory memory of a device comprising:
   a. acquiring video content, including storing the video content in the non-transitory memory of the device; and
   b. processing the video content, including implementing joint re-sampling and bit-shift without previously determining if a base layer and an enhancement layer of the video content are a same size, have a same bit-depth, and have a zero offset.
16. The method of clause 15 wherein processing further includes generating a bitstream.
17. The method of clause 15 further comprising displaying the video content on a display.
18. The method of clause 15 wherein processing further includes performing a base layer encoding loop and an enhancement layer encoding loop.
19. The method of clause 15 wherein the joint re-sampling and bit-shift include determining if the base layer and the enhancement layer are the same size, and if the base layer and the enhancement layer are the same size, then bit-shift within a window is performed, and if the base layer and the enhancement layer are not the same size, then re-sampling and bit-shift is performed within the window.
20. A system comprising:
   a. an image sensor configured for acquiring video content; and
   b. a processing device configured for processing the video content, including implementing joint re-sampling and bit-shift without previously determining if a base layer and an enhancement layer of the video content are a same size, have a same bit-depth, and have a zero offset; and
   c. a display device configured for displaying the video content.
21. The system of clause 20 wherein processing further includes generating a bitstream.
22. The system of clause 20 wherein processing further includes performing a base layer encoding loop and an enhancement layer encoding loop.
23. The system of clause 20 wherein the joint re-sampling and bit-shift include determining if the base layer and the enhancement layer are the same size, and if the base layer and the enhancement layer are the same size, then bit-shift within a window is performed, and if the base layer and the enhancement layer are not the same size, then re-sampling and bit-shift is performed within the window.
24. An apparatus comprising:
   a. a non-transitory memory for storing an application, the application for:
      i. acquiring video content, including storing the video content in the non-transitory memory of the device; and
      ii. processing the video content, including implementing joint re-sampling and bit-shift without previously determining if a base layer and an enhancement layer of the video content are a same size, have a same bit-depth, and have a zero offset; and
   b. a processing component coupled to the memory, the processing component configured for processing the application.
25. The apparatus of clause 24 wherein processing further includes generating a bitstream.
26. The apparatus of clause 24 further comprising a display configured for displaying the video content.
27. The apparatus of clause 24 wherein processing further includes performing a base layer encoding loop and an enhancement layer encoding loop.
28. The apparatus of clause 24 wherein the joint re-sampling and bit-shift include determining if the base layer and the enhancement layer are the same size, and if the base layer and the enhancement layer are the same size, then bit-shift within a window is performed, and if the base layer and the enhancement layer are not the same size, then re-sampling and bit-shift is performed within the window.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method programmed in a non-transitory memory of a device comprising:
a. acquiring video content, including storing the video content in the non-transitory memory of the device; and
b. processing the video content, including joint re-sampling and bit-shift including determining if the base layer and the enhancement layer are a same size, and if the base layer and the enhancement layer are the same size, then bit-shift within a window is performed, and if the base layer and the enhancement layer are not the same size, then re-sampling and bit-shift is performed within the window.

2. The method of claim 1 wherein processing further includes generating a bitstream.

3. The method of claim 1 further comprising displaying the video content on a display.

4. The method of claim 1 wherein processing further includes performing a base layer encoding loop and an enhancement layer encoding loop.

5. The method of claim 1 wherein processing further includes joint re-sampling and bit-shift if any of the following is not true: the base layer and the enhancement layer of the video content are the same size, have a same bit-depth, and have a zero offset.

6. A system comprising:
a. an image sensor configured for acquiring video content; and
b. a processing device configured for processing the video content, including joint re-sampling and bit-shift including determining if the base layer and the enhancement layer are a same size, and if the base layer and the enhancement layer are the same size, then bit-shift within a window is performed, and if the base layer and the enhancement layer are not the same size, then re-sampling and bit-shift is performed within the window; and
c. a display device configured for displaying the video content.

7. The system of claim 6 wherein processing further includes generating a bitstream.

8. The system of claim 6 wherein processing further includes performing a base layer encoding loop and an enhancement layer encoding loop.

9. The system of claim 6 wherein processing further includes joint re-sampling and bit-shift if any of the following is not true: the base layer and the enhancement layer of the video content are the same size, have a same bit-depth, and have a zero offset.

10. An apparatus comprising:
a. a non-transitory memory for storing an application, the application for:
i. acquiring video content, including storing the video content in the non-transitory memory of the device; and
ii. processing the video content, including joint re-sampling and bit-shift including determining if the base layer and the enhancement layer are a same size, and if the base layer and the enhancement layer are the same size, then bit-shift within a window is performed, and if the base layer and the enhancement layer are not the same size, then re-sampling and bit-shift is performed within the window; and
b. a processing component coupled to the memory, the processing component configured for processing the application.

11. The apparatus of claim 10 wherein processing further includes generating a bitstream.

12. The apparatus of claim 10 further comprising a display configured for displaying the video content.

13. The apparatus of claim 10 wherein processing further includes performing a base layer encoding loop and an enhancement layer encoding loop.

14. The apparatus of claim 10 wherein processing further includes joint re-sampling and bit-shift if any of the following is not true: the base layer and the enhancement layer of the video content are the same size, have a same bit-depth, and have a zero offset.

15. A method programmed in a non-transitory memory of a device comprising:
a. acquiring video content, including storing the video content in the non-transitory memory of the device; and
b. processing the video content, including implementing joint re-sampling and bit-shift without previously determining if a base layer and an enhancement layer of the video content are a same size, have a same bit-depth, and have a zero offset.

16. The method of claim 15 wherein processing further includes generating a bitstream.

17. The method of claim 15 further comprising displaying the video content on a display.

18. The method of claim 15 wherein processing further includes performing a base layer encoding loop and an enhancement layer encoding loop.

19. The method of claim 15 wherein the joint re-sampling and bit-shift include determining if the base layer and the enhancement layer are the same size, and if the base layer and the enhancement layer are the same size, then bit-shift within a window is performed, and if the base layer and the enhancement layer are not the same size, then re-sampling and bit-shift is performed within the window.

20. A system comprising:
a. an image sensor configured for acquiring video content; and
b. a processing device configured for processing the video content, including implementing joint re-sampling and bit-shift without previously determining if a base layer and an enhancement layer of the video content are a same size, have a same bit-depth, and have a zero offset; and
c. a display device configured for displaying the video content.

21. The system of claim 20 wherein processing further includes generating a bitstream.

22. The system of claim 20 wherein processing further includes performing a base layer encoding loop and an enhancement layer encoding loop.

23. The system of claim 20 wherein the joint re-sampling and bit-shift include determining if the base layer and the enhancement layer are the same size, and if the base layer and the enhancement layer are the same size, then bit-shift within a window is performed, and if the base layer and the enhancement layer are not the same size, then re-sampling and bit-shift is performed within the window.

24. An apparatus comprising:
a. a non-transitory memory for storing an application, the application for:
i. acquiring video content, including storing the video content in the non-transitory memory of the device; and
ii. processing the video content, including implementing joint re-sampling and bit-shift without previously determining if a base layer and an enhancement layer of the video content are a same size, have a same bit-depth, and have a zero offset; and
b. a processing component coupled to the memory, the processing component configured for processing the application.

25. The apparatus of claim 24 wherein processing further includes generating a bitstream.

26. The apparatus of claim 24 further comprising a display configured for displaying the video content.

27. The apparatus of claim 24 wherein processing further includes performing a base layer encoding loop and an enhancement layer encoding loop.

28. The apparatus of claim 24 wherein the joint re-sampling and bit-shift include determining if the base layer and the enhancement layer are the same size, and if the base layer and the enhancement layer are the same size, then bit-shift within a window is performed, and if the base layer and the enhancement layer are not the same size, then re-sampling and bit-shift is performed within the window.
